(19) United States
(12) Patent Application Publication
(10) Pub. No.: US 2012/0144420 A1
(43) Pub. Date: Jun. 7, 2012

(54) TARGETED ADVERTISEMENT DISTRIBUTION IN AN SDV ENVIRONMENT

(75) Inventors: Christopher S. Del Sordo, Souderton, PA (US); Albert F. Elcock, West Chester, PA (US); Patrick J. Leary, Horsham, PA (US); Yeqing Wang, Horsham, PA (US)

(73) Assignee: GENERAL INSTRUMENT CORPORATION, Horsham, PA (US)

(21) Appl. No.: 12/962,306

(22) Filed: Dec. 7, 2010

(51) Int. Cl. H04N 7/025

(52) U.S. Cl. 725/35

(57) ABSTRACT

A system and method for distributing targeted advertisements in a switched digital video system. The method monitors a content stream associated with a channel selected by a subscriber, where the content stream includes an advertisement segment having a start time and an end time, and an advertisement replacement opportunity inserted in the content stream. The method detects the advertisement replacement opportunity at a detection time that is prior to the start time of the advertisement segment, and sends a request to select an advertisement replacement for the advertisement segment, thereby broadcasting a service associated with the advertisement replacement prior to the start time for the advertisement segment. The method receives tune data to identify an advertisement replacement stream associated with the advertisement replacement, and tunes to the advertisement replacement at the start time for the advertisement segment.

### BACKGROUND

A digital video broadcast system allows a multiple system operator (MSO) to deliver television programs and multimedia services to subscribers. The capacity, or bandwidth, of the system determines the programs and services that the MSO delivers. In legacy broadcast systems, the MSO sends all of the available programs and services to the subscriber's set-top box on a single cable. Thus, the only way to increase the programs and services available to subscribers in legacy broadcast systems is to increase the bandwidth.

A switched digital video (SDV) system is an improvement to the legacy broadcast systems. The SDV system requires less bandwidth to deliver high-bandwidth digital services by allowing the MSO to send only the content requested by a service group, where each service group includes a set of set-top boxes with visibility to a common set of switched edge quadrature amplitude modulator (QAM) devices. To make this possible, the subscriber's set-top box communicates with a network side video server to request the program that the subscriber wants to watch in real time. The SDV system responds by delivering the requested program to the subscriber's service group. Thus, the service group only receives the programs that subscribers in the service group are watching.

A current focus for the MSO is the development of targeted advertisement technology (i.e., advertisements that are placed so as to reach consumers based on various traits, such as demographics, purchase history, observed behavior, or the like). One of the issues for the MSO is the need for network bandwidth to distribute the targeted advertisements. Even though the targeted advertisements are short in length, there is a need to have many different targeted advertisements to satisfy the various targeted population groups they need to serve. It is anticipated that as targeted advertisement technology grows, there will be an increase in the targeted advertisements distributed over the network. Furthermore, the need for bandwidth will increase because subscribers want the targeted advertisements to be in high-definition (HD) format (i.e., The Moving Picture Experts Group (MPEG) MPEG-4 or MPEG-2 high profile format). In addition, since these targeted advertisements generate a significant revenue stream for the MSO, the time delay to transition from a primary television program, to a targeted advertisement, and back to the primary television program is lost advertisement time that negatively impacts the revenue stream.

There is a demand for a method and system for distributing targeted advertisements in an SDV system that reduces the network bandwidth necessary for the distribution of HD and standard-definition (SD) targeted advertisements. The presently disclosed invention satisfies this demand.

### SUMMARY

Aspects of the present invention provide a system and method for distributing targeted advertisements in a switched digital video system. The method monitors a content stream associated with a channel selected by a subscriber, where the content stream includes an advertisement segment having a start time and an end time, and an advertisement replacement opportunity inserted in the content stream. The method detects the advertisement replacement opportunity at a detection time prior to the start time of the advertisement segment, and sends a request to select an advertisement replacement for the advertisement segment, thereby broadcasting a service associated with the advertisement replacement prior to the start time for the advertisement segment. The method receives tune data to identify an advertisement replacement stream associated with the advertisement replacement, and tunes to the advertisement replacement at the start time for the advertisement segment.

### BRIEF DESCRIPTION OF THE DRAWINGS

FIG. 1 is a message flow diagram that illustrates one embodiment of the hardware components of a system that performs the present invention.

FIG. 2 is a block diagram that illustrates, in detail, one embodiment of the hardware components shown in FIG. 1.

FIG. 3 is a message flow diagram that illustrates methods according to various embodiments of the present invention.

### DETAILED DESCRIPTION

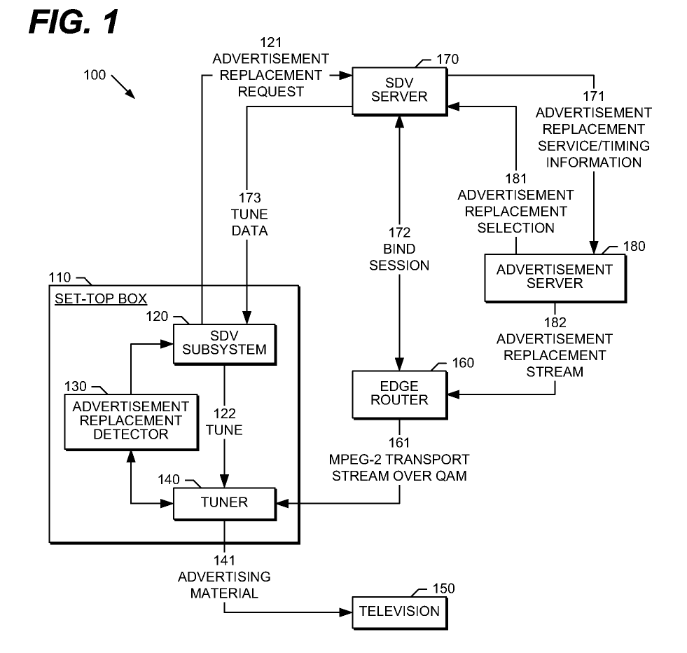

FIG. 1 is a message flow diagram that illustrates one embodiment of the hardware components of a system that performs the present invention. A switched digital video (SDV) system 100 includes a set-top box 110, television 150, edge router 160, SDV server 170, and advertisement server 180. In one embodiment, a network (not shown), such as a hybrid-fiber coaxial (HFC) network, connects the set-top box 110 and the television 150 to the edge router 160, SDV server 170, and the advertisement server 180. In another embodiment, a network (not shown) connects the advertisement server 180 to the edge router 160 and SDV server 170.

The set-top box 110 is a computing device that connects the television 150 and an external signal source, turning the signal into a content stream that the television 150 displays. The set-top box 110 shown in FIG. 1 includes an SDV subsystem 120, advertisement replacement detector 130, and tuner 140.

The edge router 160 is a computing device that transfers data between a local area network and a wide area network, choosing the most effective paths to use when sending or receiving data. The edge router 160 shown in FIG. 1 includes quadrature amplitude modulators (QAMs) that enable the transmission of a multiplex of digital streams via a radio-frequency (RF) carrier.

The SDV server 170 is a computing device that receives channel change requests for switched content from the set-top box 110, binds that content to a session on the edge router 160 that is associated with a QAM feeding the service group for the set-top box 110, and responds to the set-top box 110 with the frequency and program number where the content may be found.

The system shown in FIG. 1 utilizes an SDV environment to send a targeted advertisement. In one embodiment, the targeted advertisement is a replacement for the primary network advertisement that is typically shown during a television program or between two television programs. One benefit of using the SDV environment to send targeted advertisements is that targeted advertisements are not required to be transmitted on the network in a continuous manner, and can be switched in based on an insertion decision made by the targeted advertisement decision engine. The decision of which targeted advertisement to select and insert is made prior to the insertion of the targeted advertisement.

The transition from a television program to a targeted advertisement is actually a service acquisition. Since the time needed to insert the targeted advertisement in the SDV system can be greater than the service acquisition time, it is possible that the consumer may miss part of the advertisement when the advertisement starts. Therefore, it is important to first make sure the advertisement is being broadcast prior to acquiring the targeted advertisement service. The present invention minimizes the time delay to transition from a primary television program, to a targeted advertisement, and back to the primary television program, thereby avoiding the loss of advertisement time (i.e., lost revenue for the MSO).

The SDV system shown in FIG. 1 saves network bandwidth because it only streams the replacement targeted advertisement to those set-top boxes 110 that indicate an advertisement replacement opportunity. Furthermore, it only consumes bandwidth if the end user actually plays the replacement targeted advertisement. The present invention removes the need in the prior art to pre-position replacement targeted advertisements (e.g., on a disk associated with the set-top box 110).

In one embodiment of the SDV system shown in FIG. 1, a subscriber uses the set-top box 110 to request a content stream to view on the television 150. The SDV server 170 receives the request for the content stream from the SDV subsystem 120 of the set-top box 110. When the content stream is available, the SDV server 170 will bind a session to the edge router 160 for delivery of the content stream. The edge router 160 then delivers the content stream, as MPEG-2 transport stream over QAM 161, to the tuner 140 which will display the content stream on the television 150.

The advertisement replacement detector 130 shown in FIG. 1 monitors the content streams that the tuner 140 receives to detect an opportunity for advertisement replacement. In one embodiment, the advertisement replacement detector 130 detects a trigger in the content stream that indicates that an advertisement transition will occur, where the advertisement server 180 inserted the trigger into the content stream, and the SDV server 170 forwarded the content stream with the trigger to the set-top box 110 via the edge router 160. In another embodiment, the advertisement replacement detector 130 detects a splice point in the content stream that indicates that an advertisement transition will occur. When such an advertisement replacement opportunity occurs, the advertisement replacement detector 130 sends a notification to the SDV subsystem 120. The notification instructs the SDV subsystem 120 to send an advertisement replacement request 121 message to the SDV server 170. In response, the SDV server 170 sends advertisement replacement service/timing information 171 to the advertisement server 180. In one embodiment, the advertisement replacement service/timing information 171 provides advertisement replacement information that indicates when to start playing the advertisement. In another embodiment, the advertisement replacement service/timing information 171 provides advertisement replacement information that indicates how to acquire the service. In another embodiment, the advertisement replacement message and the advertisement replacement service/timing information 171 include demographic information for the subscriber, time duration for the advertisement segment, identification information for the subscriber, purchasing preferences, and the like that help the advertisement server 180 to select an advertisement that will target the subscriber or an event or occasion.

In response to the receipt of the advertisement replacement service/timing information 171, the advertisement server 180 prepares an advertisement replacement to present to the subscriber. In one embodiment, the advertisement replacement service/timing information 171, which includes the subscriber's characteristics and preferences (i.e., demographic information, timing information, identification information, purchasing preferences, and the like), is input to a decision engine that the advertisement server 180 uses to select an appropriate advertisement replacement. The advertisement server 180 sends an advertisement replacement selection 181 message to the SDV server 170. In one embodiment, the advertisement replacement selection 181 message informs the SDV server 170 of the service information of the advertisement replacement. The SDV server 170 establishes a bind session 172 with the edge router 160, proceeds to broadcast the advertisement replacement, and learns the tuning information needed for the set-top box 110 tune to be successful. The SDV server 170 sends a tune data 173 message to the SDV subsystem 120 to provide the tuning information to the set-top box 110. In one embodiment, the tune data 173 message includes timing information to synchronize the set-top box 110 tune with the playing of the replacement target advertisement that the advertisement server 180 provides as an advertisement replacement stream 182 to the edge router 160. In another embodiment, the tune data 173 is a message that can contain timing information which the set-top box 110 evaluates to decide when to tune, or the SDV server 170 can transmit the message with precise timing where the set-top box 110 reacts immediately on the receipt of the message. When the SDV subsystem 120 in the set-top box 110 receives the tune data 173 message, it sends a tune 122 message to the tuner 140 to tune to the replacement target advertisement so that advertising material 141 is displayed on the television 150.

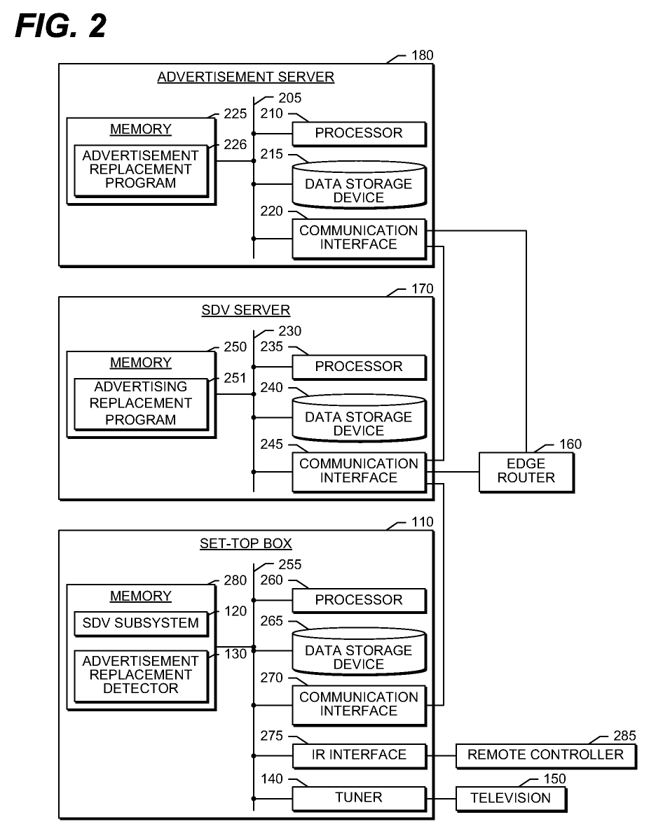

FIG. 2 is a block diagram that illustrates, in detail, one embodiment of the hardware components shown in FIG. 1. In particular, FIG. 2 illustrates the hardware components and software comprising the advertisement server 180, SDV server 170, and set-top box 110 shown in FIG. 1.

The advertisement server 180, in one embodiment, is a general-purpose computing device that performs the present invention. A bus 205 is a communication medium that connects a processor 210, data storage device 215 (such as a Serial ATA (SATA) hard disk drive, optical drive, Small Computer System Interface (SCSI) disk, flash memory, or the like), communication interface 220, and memory 225 (such as Random Access Memory (RAM), Dynamic RAM (DRAM), non-volatile computer memory, flash memory, or the like). The communication interface 220 connects the advertisement server 180 to the edge router 160 and the SDV server 170. In one embodiment, the implementation of the present invention on the advertisement server 180 is an application-specific integrated circuit (ASIC).

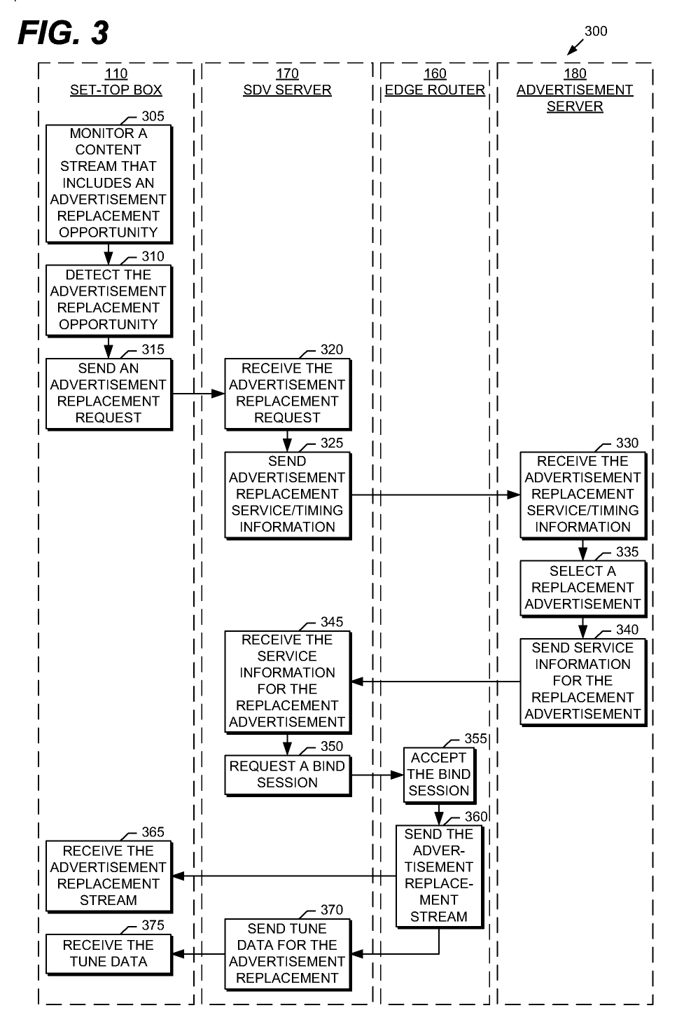

The processor 210 performs the disclosed methods by executing the sequences of operational instructions that comprise each computer program resident in, or operative on, the memory 225. The reader should understand that the memory 225 may include operating system, administrative, and database programs that support the programs disclosed in this application. In one embodiment, the configuration of the memory 225 of the advertisement server 180 includes an advertisement replacement program 226 that performs the methods of the present invention disclosed in detail in FIG. 1 and FIG. 3. When the processor 210 performs the disclosed methods, it stores intermediate results in the memory 225 or data storage device 215. In another embodiment, the memory 225 may swap these programs, or portions thereof, in and out of the memory 225 as needed, and thus may include fewer than all of these programs at any one time.

The SDV server 170, in one embodiment, is a general-purpose computing device that performs the present invention. A bus 230 is a communication medium that connects a processor 235, data storage device 240 (such as a Serial ATA (SATA) hard disk drive, optical drive, Small Computer System Interface (SCSI) disk, flash memory, or the like), communication interface 245, and memory 250 (such as Random Access Memory (RAM), Dynamic RAM (DRAM), non-volatile computer memory, flash memory, or the like). The communication interface 245 connects the SDV server 170 to the advertisement server 180, edge router 160, and set-top box 110. In one embodiment, the implementation of the present invention on the SDV server 170 is an application-specific integrated circuit (ASIC).

The processor 235 performs the disclosed methods by executing the sequences of operational instructions that comprise each computer program resident in, or operative on, the memory 250. The reader should understand that the memory 250 may include operating system, administrative, and database programs that support the programs disclosed in this application. In one embodiment, the configuration of the memory 250 of the SDV server 170 includes an advertisement replacement program 251 that performs the methods of the present invention disclosed in detail in FIG. 1 and FIG. 3. When the processor 235 performs the disclosed methods, it stores intermediate results in the memory 250 or data storage device 240. In another embodiment, the memory 250 may swap these programs, or portions thereof, in and out of the memory 250 as needed, and thus may include fewer than all of these programs at any one time.

The set-top box 110, in one embodiment, is a general-purpose computing device that performs the present invention. A bus 255 is a communication medium that connects a processor 260, data storage device 265 (such as a Serial ATA (SATA) hard disk drive, optical drive, Small Computer System Interface (SCSI) disk, flash memory, or the like), communication interface 270, infrared (IR) interface 275, tuner 140, and memory 280 (such as Random Access Memory (RAM), Dynamic RAM (DRAM), non-volatile computer memory, flash memory, or the like). The communication interface 270 connects the set-top box 110 to the SDV server 170. The IR interface 275 connects the set-top box 110 to a remote controller 285. The tuner 140 connects the set-top box 110 to a display device such as a television 150, and sends the video content that the television 150 screen displays. In one embodiment, the implementation of the present invention on the set-top box 110 is an application-specific integrated circuit (ASIC).

The processor 260 performs the disclosed methods by executing the sequences of operational instructions that comprise each computer program resident in, or operative on, the memory 280. The reader should understand that the memory 280 may include operating system, administrative, and database programs that support the programs disclosed in this application. In one embodiment, the configuration of the memory 280 of the set-top box 110 includes an SDV subsystem 120, and advertisement replacement detector 130 that perform the methods of the present invention disclosed in detail in FIG. 1 and FIG. 3. When the processor 260 performs the disclosed methods, it stores intermediate results in the memory 280 or data storage device 265. In another embodiment, the memory 280 may swap these programs, or portions thereof, in and out of the memory 280 as needed, and thus may include fewer than all of these programs at any one time.

FIG. 3 is a flow diagram that illustrates a method according to one embodiment of the present invention. In particular, FIG. 3 illustrates the communication between the set-top box 110, SDV server 170, edge router 160, and advertisement server 180.

The process 300 shown in FIG. 3, with reference to FIG. 1 and FIG. 2, begins when the set-top box 110 monitors a content stream that includes an advertisement replacement opportunity (step 305) inserted in the content stream. The tuner 140 for the set-top box 110 is receiving the content stream in response to a request from a subscriber to tune the set-top box 110 to a channel in an SDV system. The process 300 monitors the content stream by examining each transport stream packet that makes up the content stream to detect an advertisement replacement opportunity (i.e., an indication that an upcoming advertisement segment in the content stream provides an opportunity to substitute a replacement advertisement for the primary advertisement). In one embodiment, the advertisement replacement opportunity is a trigger that the advertisement server 180 inserts into the content stream. When the process 300 encounters a trigger in the content stream, it examines the trigger to identify a start time for the advertisement segment, end time for the advertisement segment, and service information for the advertisement segment. The trigger is an indicator of a transition of the content stream to a service for the advertisement segment, and provides a seamless transition when tuning to the advertisement segment. In another embodiment, the advertisement replacement opportunity is a splice point in the content stream. When the process 300 encounters the splice point in the content stream, it examines the splice point to identify a start time for the advertisement segment, end time for the advertisement segment, and advertisement replacement splice service information. The splice point is an indicator of a transition of the content stream to a service for the advertisement segment, and provides a seamless transition when tuning to the advertisement segment. When the process 300 detects an advertisement replacement opportunity in the content stream (step 310), the SDV subsystem 120 of the set-top box 110 sends an advertisement replacement request 121 message to the SDV server 170 (step 315). In one embodiment, the advertisement replacement request 121 message includes advertisement replacement service information, demographic information for the subscriber, time duration for the advertisement replacement segment, identification information for the subscriber, purchasing preferences, and the like.

The SDV server 170 receives the advertisement replacement request 121 message (step 320) and sends advertisement replacement service/timing information 171 to the advertisement server 180 (step 325). In one embodiment, the advertisement replacement service/timing information 171 includes advertisement replacement information that indicates when to start playing the advertisement. In another embodiment, the advertisement replacement service/timing information 171 provides advertisement replacement information that indicates how to acquire the service. In another embodiment, the advertisement replacement service/timing information 171 includes, demographic information for the subscriber, time duration for the advertisement segment, identification information for the subscriber, purchasing preferences, and the like.

The advertisement server 180 receives the advertisement replacement service/timing information 171 (step 330) and selects a replacement message (step 335). In one embodiment, the advertisement server 180 includes a decision engine to select a targeted advertisement as the replacement advertisement based on consideration of the subscriber's characteristics and preferences obtained from demographic information for the subscriber, time duration for the advertisement segment, identification information for the subscriber, purchasing preferences, and the like. Once the advertisement server 180 selects the replacement advertisement, the advertisement server 180 sends an advertisement replacement selection 181 message to the SDV server 170 to provide service information for the replacement advertisement to the SDV server 170 (step 340). In one embodiment, the service information identifies the service and associated advertisement tuning information necessary for the SDV server 170 to set up the service and then indicates to the edge router 160 to begin broadcasting the replacement advertisement. In another embodiment, the advertisement server 180 also sends timing information for the replacement advertisement to instruct the SDV server 170 when to start playing the replacement advertisement, and the time duration for the replacement advertisement. This also results in the edge router 160 broadcasting the replacement advertisement.

The SDV server 170 receives the service information for the replacement advertisement in the advertisement replacement selection 181 message (step 345) and sends a request to the edge router 160 for a bind session 172 (step 350). The edge router 160 accepts the request for the bind session 172 (step 355) and prepares to route the replacement advertisement. The edge router 160 sends an advertisement replacement stream 182 that includes the advertisement replacement (step 360) so that the tuner 140 on the set-top box 110 receives the advertisement replacement stream 182 (step 365) prior to the start time for the advertisement replacement segment in the content stream. The edge router 160 signals the SDV server 170 that the session is bound. The SDV server 170 then sends tune data 173 for the advertisement replacement to the SDV subsystem 120 of the set-top box 110 (step 370). In various embodiments, the tune data 173 includes a Moving Picture Experts Group service number, Internet Protocol multicast, a frequency, a service identifier, and the like. The set-top box 110 receives the tune data 173 (step 375) and prepares the tuner 140 to synchronize the set-top box 110 with the playing of the advertisement replacement. In one embodiment, the tune data 173 includes timing information that the set-top box 110 evaluates and uses to determine when to tune to the advertisement replacement. In another embodiment, the tune data 173 includes precise timing and the set-top box 110 reacts immediately upon receipt of the tune data 173.

Although the disclosed embodiments describe a fully functioning method and system for distributing targeted advertisements in an SDV system, the reader should understand that other equivalent embodiments exist. Since numerous modifications and variations will occur to those reviewing this disclosure, the method and system for distributing targeted advertisements in an SDV system is not limited to the exact construction and operation illustrated and disclosed. Accordingly, this disclosure intends all suitable modifications and equivalents to fall within the scope of the claims.

We claim:

1. A method, comprising:
monitoring a content stream associated with a channel in a switched digital video system, the content stream including an advertisement segment having a start time and an end time, and an advertisement replacement opportunity inserted in the content stream;
detecting the advertisement replacement opportunity in the content stream at a detection time that is prior to the start time of the advertisement segment;
sending a request to select an advertisement replacement for the advertisement segment, thereby causing a broadcast of a service associated with the advertisement replacement prior to the start time of the advertisement segment;
receiving tune data to identify an advertisement replacement stream associated with the advertisement replacement; and
tuning to the advertisement replacement stream at the start time for the advertisement segment.

2. The method of claim 1, wherein the content stream is a sequential content stream.

3. The method of claim 1, wherein the monitoring of the content stream further comprises:
receiving the content stream as a time sequence of packets; and
examining each packet.

4. The method of claim 1, wherein the detecting of the advertisement replacement opportunity further comprises:
detecting at least one trigger in the content stream, said at least one trigger identifying the start time for the advertisement segment, the end time for the advertisement segment, and service information for the advertisement segment,
wherein said at least one trigger is an indicator of a transition of the content stream to a service for the advertisement segment, and an opportunity to replace the advertisement segment with the advertisement replacement, and
wherein said at least one trigger provides a seamless transition when tuning to the advertisement segment, or the advertisement replacement.

5. The method of claim 1, wherein the detecting of the advertisement replacement opportunity further comprises:
detecting at least one splice point in the content stream, said at least one splice point identifying the start time for the advertisement segment, the end time for the advertisement segment, and advertisement replacement splice service information,
wherein said at least one splice point is an indicator of a transition of the content stream to a service for the advertisement segment, and an opportunity to replace the advertisement segment with the advertisement replacement, and
wherein said at least one splice point provides a seamless transition when tuning to the advertisement segment, or the advertisement replacement.

6. The method of claim 1, wherein the request to select the advertisement replacement for the advertisement segment includes at least one of demographic information for a subscriber to the content stream, a time duration for the advertisement segment, identification information for the subscriber, and purchasing preferences for the subscriber.

7. The method of claim 1, wherein the advertisement replacement is targeted to address a characteristic or a preference associated with a subscriber to the content stream.

8. The method of claim 1, wherein the tune data includes at least one of a Moving Picture Experts Group service number, Internet Protocol multicast, a frequency, and a service identifier.

9. The method of claim 1, wherein a time difference between the detection time and the start time of the advertisement segment is greater than a service set up time for the advertisement replacement stream.

10. A system, comprising:
a memory device resident in a computing device; and
a processor disposed in communication with the memory device, the processor configured to:
monitor a content stream associated with a channel in a switched digital video system, the content stream including an advertisement segment having a start time and an end time, and an advertisement replacement opportunity inserted in the content stream;
detect the advertisement replacement opportunity in the content stream at a detection time that is prior to the start time of the advertisement segment;
send a request to select an advertisement replacement for the advertisement segment, thereby causing a broadcast of a service associated with the advertisement replacement prior to the start time of the advertisement segment;
receive tune data to identify an advertisement replacement stream associated with the advertisement replacement; and
tuning to the advertisement replacement stream at the start time for the advertisement segment.

11. The system of claim 10, wherein a time difference between the detection time and the start time of the advertisement segment is greater than a service set up time for the advertisement replacement stream.

12. A non-transitory computer-readable medium, comprising computer-executable instructions that, when executed on a computing device, perform steps of:
monitoring a content stream associated with a channel in a switched digital video system, the content stream including an advertisement segment having a start time and an end time, and an advertisement replacement opportunity inserted in the content stream;
detecting the advertisement replacement opportunity in the content stream at a detection time that is prior to the start time of the advertisement segment;
sending a request to select an advertisement replacement for the advertisement segment, thereby causing a broadcast of a service associated with the advertisement replacement prior to the start time of the advertisement segment;
receiving tune data to identify an advertisement replacement stream associated with the advertisement replacement; and
tuning to the advertisement replacement stream at the start time for the advertisement segment.

13. A method, comprising:
receiving a request to select an advertisement replacement for an advertisement segment of a content stream associated with a channel in a switched digital video system, the advertisement segment having a start time and an end time, wherein a receipt time of the request is prior to the start time for the advertisement segment;
selecting the advertisement replacement for the advertisement segment;
broadcasting a service associated with the advertisement replacement prior to the start time of the advertisement segment;
sending tune data to identify an advertisement replacement stream associated with the advertisement replacement; and
sending the advertisement replacement stream at the start time for the advertisement segment.

14. The method of claim 13, wherein the content stream is a sequential content stream.

15. The method of claim 13, wherein the request to select the advertisement replacement for the advertisement segment includes at least one of demographic information for a subscriber to the content stream, a time duration for the advertisement segment, identification information for the subscriber, and purchasing preferences for the subscriber.

16. The method of claim 13, wherein the advertisement replacement is targeted to address a characteristic or a preference associated with a subscriber to the content stream.

17. The method of claim 13, wherein a time difference between the receipt time of the request and the start time of the advertisement segment is greater than a service set up time for the advertisement replacement stream.

18. A system, comprising:
a memory device resident in a computing device; and
a processor disposed in communication with the memory device, the processor configured to:
receive a request to select an advertisement replacement for an advertisement segment of a content stream associated with a channel in a switched digital video system, the advertisement segment having a start time and an end time, wherein a receipt time of the request is prior to the start time for the advertisement segment;
select the advertisement replacement for the advertisement segment;
broadcast a service associated with the advertisement replacement prior to the start time of the advertisement segment;
send tune data to identify an advertisement replacement stream associated with the advertisement replacement; and
send the advertisement replacement stream at the start time for the advertisement segment.

19. The system of claim 18, wherein a time difference between the receipt time of the request and the start time of the advertisement segment is greater than a service set up time for the advertisement replacement stream.

20. A non-transitory computer-readable medium, comprising computer-executable instructions that, when executed on a computing device, perform steps of:
receiving a request to select an advertisement replacement for an advertisement segment of a content stream associated with a channel in a switched digital video system, the advertisement segment having a start time and an end time, wherein a receipt time of the request is prior to the start time for the advertisement segment;
selecting the advertisement replacement for the advertisement segment;
broadcasting a service associated with the advertisement replacement prior to the start time of the advertisement segment;
sending tune data to identify an advertisement replacement stream associated with the advertisement replacement; and
sending the advertisement replacement stream at the start time for the advertisement segment.
